(19) United States
(12) Patent Application Publication
(10) Pub. No.: US 2025/0389832 A1
(43) Pub. Date: Dec. 25, 2025

(54) SIGNAL PROCESSING METHOD, APPARATUS, AND ELECTRONIC DEVICE

(71) Applicant: Lenovo (Beijing) Limited, Beijing (CN)

(72) Inventors: Shaolong YU, Beijing (CN); Rongbin XIAO, Beijing (CN)

(21) Appl. No.: 19/245,872

(22) Filed: Jun. 23, 2025

(30) Foreign Application Priority Data
Jun. 24, 2024 (CN) 202410823712.7

(51) Int. Cl. G01S 7/527; G01S 15/06

(52) U.S. Cl. CPC G01S 7/527; G01S 15/06

(57) ABSTRACT

A signal processing method includes emitting a target sound wave of a first frequency, sampling based on a target frequency to obtain a target point number of sampling points, converting the echo signal of the first frequency to an echo signal of a second frequency, and determining a target parameter of the object based on the echo signal of the second frequency. The target point number of sampling points are used to restore an echo signal generated when the target sound wave of the first frequency encounters an object. The first frequency belongs to a first range, the second frequency belongs to a second range, and a minimum value of the first range is greater than a maximum value of the second range. The target parameter is related to a position of the object.

### CROSS-REFERENCE TO RELATED APPLICATION

The present disclosure claims priority to Chinese Patent Application No. 202410823712.7, filed on Jun. 24, 2024, the entire content of which is incorporated herein by reference.

### TECHNICAL FIELD

The present disclosure relates to the signal processing technology field and, more

particularly, to a signal processing method, a signal processing apparatus, and an electronic device.

### BACKGROUND

In a scenario of emitting signals by an ultrasound wave, when the object approaches/moves away from an emission source, an echo signal produces a frequency shift, and information such as a moving speed and distance of the object is calculated based on the frequency shift.

When the moving speed and distance of the object are calculated based on the frequency shift of the echo signal, a higher frequency resolution is required for the echo signal. A longer sampling data cumulation length is performed on the echo signal. A Fourier transform (such as FFT) is performed on the echo signal sampling data with a longer data accumulation length. By accumulating the longer length of the echo signal sampling data and performing the FFT on the accumulated data, although the high frequency resolution required by the echo signal is satisfied, the FFT has problems such as large data processing volume, long time, and long time delay.

### SUMMARY

An aspect of the present disclosure provides a signal processing method. The method includes emitting a target sound wave of a first frequency, sampling based on a target frequency to obtain a target point number of sampling points, converting the echo signal of the first frequency to an echo signal of a second frequency, and determining a target parameter of the object based on the echo signal of the second frequency. The target point number of sampling points are used to restore an echo signal generated when the target sound wave of the first frequency encounters an object. The first frequency belongs to a first range, the second frequency belongs to a second range, and a minimum value of the first range is greater than a maximum value of the second range. The target parameter is related to a position of the object.

An aspect of the present disclosure provides a signal processing apparatus, including an emission module, a sampling module, a conversion module, and a determination module. The emission module is configured to emit a target sound wave of a first frequency. The sampling module is configured to sample based on a target frequency to obtain a target point number of sampling points. The target point number of sampling points are used to restore an echo signal generated when the target sound wave of the first frequency encounters an object. The conversion module is configured to convert the echo signal of the first frequency into an echo signal of a second frequency. The first frequency belongs to a first range, the second frequency belongs to a second range, and a minimum value of the first range is greater than a maximum value of the second range. The determination module is configured to determine a target parameter of the object based on the echo signal of the second frequency. The target parameter is related to a position of the object.

An aspect of the present disclosure provides an electronic device, including an emitter, a receiver, and a processor. The emitter is configured to emit a target sound wave of a first frequency. The receiver is configured to receive an echo signal generated when the target sound wave of the first frequency encounters an object. The echo signal is restored through a target point number of sampling points obtained by sampling based on a target frequency. The processor is configured to determine a target parameter of the object based on the echo signal received by the receiver and convert the echo signal of the first frequency into an echo signal of a second frequency. The target parameter is related to a position of the object. The first frequency belongs to a first range, the second frequency belongs to a second range, and a minimum value of the first range is greater than a maximum value of the second range.

### BRIEF DESCRIPTION OF THE DRAWINGS

FIG. 1 illustrates a schematic flowchart of a signal processing method according to some embodiments of the present disclosure.

FIG. 2 illustrates a schematic diagram of determining a target parameter of an object based on a return wave signal of a second frequency according to some embodiments of the present disclosure.

FIG. 3 illustrates a schematic flowchart of another signal processing method according to some embodiments of the present disclosure.

FIG. 4 and FIG. 5 illustrate schematic Doppler effect diagrams after FFT processing according to some embodiments of the present disclosure.

FIG. 6 illustrates a schematic structural diagram of a signal processing apparatus according to some embodiments of the present disclosure.

FIG. 7 illustrates a schematic structural diagram of an electronic device according to some embodiments of the present disclosure.

### DETAILED DESCRIPTION OF THE EMBODIMENTS

The technical solutions of embodiments of the present disclosure are described in detail in connection with the accompanying drawings of embodiments of the present disclosure. Apparently, the embodiments described are only some embodiments of the present disclosure, and not all embodiments. Based on embodiments of the present disclosure, all other embodiments obtained by those skilled in the art without creative effort shall fall within the scope of the present disclosure.

Embodiments of the present disclosure provide a signal processing method, a signal processing apparatus, and an electronic device, which can be configured to solve the problems of large data processing amount, long time cost, and high time delay when performing Fourier transform on the echo signal sampling data with a long accumulation length.

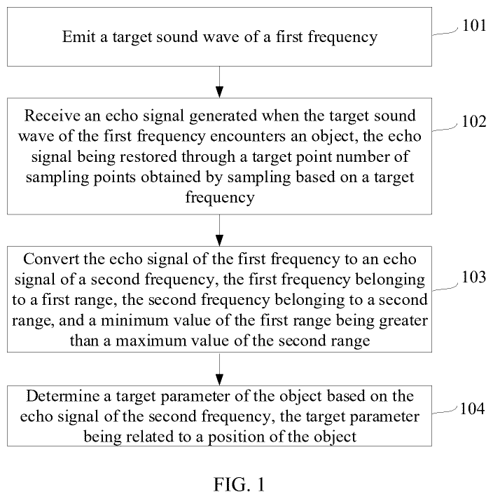

FIG. 1 illustrates a schematic flowchart of a signal processing method according to some embodiments of the present disclosure. The signal processing method of embodiments of the present disclosure includes steps 101 to 104.

At 101, a target sound wave of a first frequency is emitted.

In some embodiments, an emitter can be configured to emit the target sound wave of the first frequency.

A frequency value or a frequency range of the first frequency can be set as needed.

In some embodiments, the target sound wave can be an ultrasound wave.

At 102, a target point number of sampling points is obtained by sampling based on the target frequency. The target point number of sampling points are used to restore the echo signal when the target sound wave of the first frequency encounters the object.

When the target sound wave, e.g., the ultrasound signal, encounters the object during the propagation process, a part of the signal energy can be absorbed by the object, and the other part of the signal energy can be reflected by the object to form the echo signal of the target sound wave.

For the echo signal of the target sound wave, e.g., ultrasound, sampling can be performed on the echo signal based on the target frequency in embodiments of the present disclosure. The target point number of the sampling points can be obtained through sampling, the echo signal when the target sound wave of the first frequency encounters the object can be restored by using the target point number of the sampling points.

In some embodiments, the object can be a mobile object, for example, an object approaching or moving away from the emitter.

The target frequency can be a sampling rate used to perform sampling on the echo signal of the target sound wave (i.e., sampling frequency). The target frequency can be a time domain sampling rate for performing sampling on the echo signal in the time domain. The value of the time domain sampling rate can be determined as needed. When the target sound wave is an ultrasound, the target frequency can be 96 kHz. 96 KHz can be a general sampling rate when the echo signal of the ultrasound is received.

In the scenario of using the ultrasound for signal emission, when the object approaches/moves away from the emission source, the echo signal can generate a frequency shift. Based on the frequency shift, the moving speed and distance of the object can be calculated. When the moving speed and distance of the object are calculated, the echo signal may need a high frequency resolution. For this requirement, a longer sampling data accumulation length can be performed on the echo signal. Moreover, the FFT can be performed on the echo signal sampling data with the longer data accumulation length to obtain a higher frequency resolution.

Based on this, in embodiments of the present disclosure, the target point number can be the echo signal sampling point number based on which a higher frequency resolution of the echo signal can be obtained through the FTT to ensure obtaining the higher frequency resolution for the echo signal.

In some embodiments, the target point number can be 8192.

At 103, the echo signal of the first frequency can be converted into an echo signal of a second frequency. The first frequency belongs to a first range, and the second frequency belongs to a second range. The minimal value of the first range can be greater than the maximum value of the second range.

The first range can be a frequency range corresponding to a high frequency, and the second range can be a frequency range corresponding to a low frequency. Correspondingly, the first frequency can be a high frequency, and the second frequency can be a low frequency.

In practical applications, the echo signal after the emitted sound wave encounters the object and the emitted sound wave have the same frequency. Thus, the echo signal of the emitted sound wave can be identified based on the frequency of the emitted sound wave. For the emitted target sound wave of the first frequency, the frequency of the echo signal of the target sound wave can be consistent with the first frequency. The echo signal of the target sound wave can be identified based on the first frequency. When the target sound wave encounters the moving object, the echo signal can generate a frequency shift. That is, a certain shift can exist between the frequency of the echo signal of the target sound wave and the frequency (i.e., the first frequency) of the emitted target sound wave. However, the frequency of the echo signal can still belong to the first frequency. That is, the echo signal of the target sound wave can still be identified based on the first frequency. Based on this, in embodiments of the present disclosure, the echo signal obtained based on the sampling in step 102 can be referred to as the echo signal of the first frequency.

After the echo signal of the first frequency is obtained, in embodiments of the present disclosure, the echo signal of the first frequency can be converted into the echo signal of the second frequency to convert the echo signal with high frequency of the target sound wave can be converted into the echo signal with low frequency. In some embodiments, the echo signal of the first frequency can be converted into an echo signal with a low frequency by multiplying the echo signal of the first frequency with a cosine wave of a corresponding frequency to obtain an echo signal of a second frequency.

For example, assume the original echo signal has a sampling frequency of 96 kHz, and the information of the original echo signal is carried in the ultrasonic frequency band of 22 kHz to 25 kHz (i.e., the first frequency is 22 kHz to 25 kHz). By multiplying the sampled echo signal of the first frequency by a 20 kHz cosine wave, the echo signal can be lowered from the high-frequency ultrasonic band of 22 kHz to 25 kHz to the low-frequency band of 2 kHz to 5 kHz (i.e., the second frequency is 2 kHz to 5 kHz). This is, the frequency of 22 kHz to 25 kHz is subtracted 20 kHz, which is determined according to characteristics of multiplying a signal by a cosine wave.

At 104, the target parameter of the object is determined based on the echo signal of the second frequency. The target parameter is a parameter related to the position of the object.

After converting the echo signal of the first frequency into the echo signal of the second frequency, the target parameter of the object can be further determined based on the echo signal of the second frequency.

The target parameter of the object can include, but is not limited to, one or more of the distances between the emitter and the object, the moving speed of the object, the movement distance, etc.

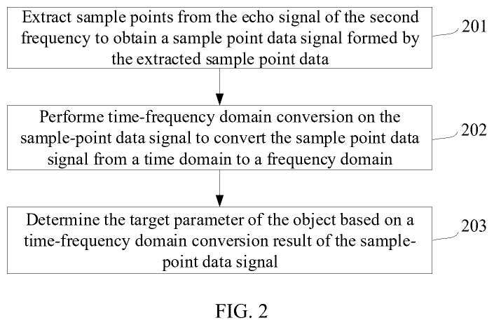

As shown in FIG. 2, determining the target parameter of the object based on the echo signal of the second frequency includes the following processes.

At 201, sample points are extracted from the echo signal of the second frequency to obtain a sample point data signal formed by the extracted sample point data.

The sample point extraction can refer to the sampling process performed on the echo signal of the second frequency.

In some embodiments, based on a certain sampling rate, the echo signal of the second frequency is sampled according to sampling rules to obtain the extracted sample point data. Correspondingly, the sample point data signal formed by the sample point data can be obtained.

After sampling, the final signal sampling frequency can be the target frequency/n. n represents the sampling rate. For example, if the target frequency (original sampling rate) is 96 kHz and the sampling rate is 8, the final signal sampling frequency can be 96 kHz/8.

The sampling rules can include, but are not limited to, ensuring that the extracted sample points are reliable and representative during sampling to allow the extracted sample point data to sufficiently reflect the characteristics of the echo signal.

Through sampling, the data processing amount required for subsequent Fourier transforms on the echo signal sampling point data can be reduced, thereby improving the processing efficiency of the Fourier transform and reducing time consumption and delay. However, the applicant has found that directly sampling the high-frequency echo signal (i.e., the echo signal of the first frequency) obtained through sampling based on the target frequency can often lead to the loss of useful signals and cause signal degradation, which adversely affects subsequent signal analysis and processing. For example, the original echo signal can have a sampling rate of 96 kHz, and the information of the original echo signal can be carried in the 22 kHz to 25 kHz range. If the original echo signal is not converted into a low-frequency echo signal, and is directly sampled using an extraction rate of 8. A signal with the original sampling rate 96 kHz can be converted into a signal with a sampling rate of 96 kHz/8=12 kHz. According to the Nyquist sampling theory, a signal with a time-domain sampling rate of 12 kHz can only represent frequencies up to 6 kHz. Thus, the 22 kHz to 25 kHz signal (i.e., the useful signal in this example) can disappear.

To address this issue, in embodiments of the present disclosure, multiplying the echo signal of the first frequency by a cosine wave to convert the echo signal into the low-frequency echo signal can avoid the loss of the useful signal during sampling. For example, for a useful signal (echo signal) carried in the high-frequency of 22 kHz to 25 kHz, the useful signal can be multiplied by a 20 kHz cosine to allow the useful signal to be carried in the low frequency of 2 kHz to 5 kHz from the high frequency of 22 kHz to 25 kHz. 2 kHz to 5 kHz is within the frequency range of up to 6 kHz, the loss of the useful signal can be avoided. The frequency conversion and sampling can be achieved without loss. The normal signal analysis and processing can be ensured in the subsequent processes.

At 202, time-frequency domain conversion is performed on the sample point data signal to convert the sample point data signal from the time domain to the frequency domain.

In some embodiments, the Fourier transform can be performed on the sampling point data signal, e.g., Fast Fourier Transform (FFT), to convert the sample point data signal from the time domain to the frequency domain.

The time domain and the frequency domain are fundamental properties of a signal. The time domain can be used to describe the relationship of a signal with respect to time, where the horizontal axis represents time and the vertical axis represents signal amplitude. The frequency domain can be a coordinate system used to describe the characteristics of the signal in terms of frequency. The horizontal axis can represent frequency, and the vertical axis can represent the amplitude of the frequency signal. In embodiments of the present disclosure, converting the sample point data signal from the time domain to the frequency domain can support the subsequent signal analysis and processing.

At 203, the target parameter of the object is determined based on the time-frequency domain conversion result of the sample point data signal.

After performing the time-frequency domain conversion on the sample point data signal, the target parameter of the object can be further determined based on the time-frequency domain conversion result of the sample point data signal.

In some embodiments, based on the time-frequency domain conversion result of the sample point data signal, the shift between the frequency of the echo signal of the target sound wave and the frequency of the target sound wave can be analyzed and determined. Based on this, based on the frequency shift, at least one of the distances between the emitter and the object, the moving speed of the object, or the movement distance can be determined.

In embodiments of the present disclosure, the data processing amount for performing the Fourier transform on the sampling point data of the echo signal can be reduced. Thus, the processing efficiency of the Fourier transform can be improved, and the processing time consumption and delay can be lowered.

The applicant has found that, when the target frequency (sampling rate) is known, the data can be accumulated with a longer length for the echo signal. The Fourier transform can be performed on the echo signal sampling data with a longer data accumulation length to obtain a higher frequency resolution. In essence, the higher frequency resolution can be obtained for the echo signal through a sufficient sampling time duration. In embodiments of the present disclosure, for the emitted target sound wave of the first frequency, obtaining the target point number of sampling points based on the target frequency (i.e., obtaining the higher frequency resolution of the echo signal based on the echo signal sampling point number) can ensure the sufficient time duration needed for obtaining the higher frequency resolution of the echo signal. After sampling, although the data point number is reduced (e.g., the sampling points change to 1024 after performing extraction with an extraction rate 8 on the sampling point data of 8192), the time duration may not be reduced (e.g., the time duration corresponding to the sampling point data of 8192). Thus, in embodiments of the present disclosure, the data processing amount when performing the Fourier transform on the sampling point data of the echo signal can be reduced through the extraction, and the processing efficiency of the Fourier transform can be improved. While the processing time consumption and delay are reduced, the sufficient sampling time duration can be ensured. Then, the higher frequency resolution for the echo signal can be obtained based on a relatively small computation amount, which satisfies the higher frequency resolution of the echo signal.

In addition, in embodiments of the present disclosure, the echo signal of the first frequency obtained through the sampling can be converted from high frequency to low frequency, and can be sampled after being converted to the low frequency. Thus, the loss of the useful signal can be avoided, and the normal signal analysis and processing can be ensured.

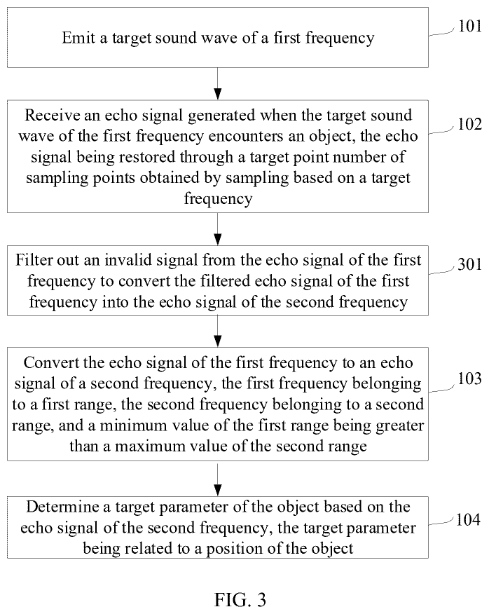

In some embodiments, as shown in the flowchart of the signal processing method in FIG. 3, the signal processing method of the present disclosure further includes the following processes between step 102 and step 103.

At 301, a useless signal is filtered from the echo signal of the first frequency, and the echo signal of the first frequency after the filtered useless signal is converted into the echo signal of the second frequency.

The sampled echo signal can normally include a useless signal. The useless signal can be information of other frequencies except for the required frequency (e.g., the first frequency). To avoid the interference of the useless signal on the subsequent signal analysis and processing, after the echo signal of the first frequency is obtained based on sampling, in embodiments of the present disclosure, an invalid signal mixed in the echo signal of the first frequency can be filtered.

In some embodiments, a time-domain frequency filter can be configured to filter out information of other frequencies except for the information of other frequencies in the echo signal to retain the signal of the required frequency.

The echo signal can carry information in the 22 kHz to 25 kHz range. A time-domain frequency filter can be configured to filter out information of other frequencies outside 22 kHz to 25 kHz. Then, the echo signal in the ultrasonic frequency band of 22 kHz to 25 kHz that needs to be observed can be preserved.

Correspondingly, as shown in FIG. 3, in some embodiments, step 103 includes converting the filtered echo signal of the first frequency into the echo signal of the second frequency.

After obtaining the echo signal of the first frequency based on sampling, in embodiments of the present disclosure, by filtering out the invalid signal in the echo signal of the first frequency, only the useful signal at the required frequency can be retained. Thus, the invalid signal can be prevented from interfering with the subsequent signal analysis and processing.

In practical applications, calculating a target parameter (e.g., the moving speed or movement distance of the object) may require feeding the results of a plurality of FFTs into an algorithm. Since the algorithm is used to calculate and output parameters, such as the moving speed and movement distance of the object based on the results of the plurality of FFTs, the sampling point data of the plurality of target point numbers can be obtained accordingly based on a plurality of rounds of sampling. Each FFT process may need to accumulate the sampling point data of the target point number based on sampling. The present disclosure can be consistent with the moment each time performing the FFT in the existing technology. For each FFT process, in both the present disclosure and the existing technology, the sampling time duration corresponding to the target point number of sampling point data can be required to ensure high frequency resolution of the echo signal, which causes the time when each time FTT is performed to be consistent in the present disclosure and the existing technology. However, the sampling point numbers for participating in the FFT process can be different. For example, the target point number can be N. Each time at FFT time in the existing technology, the N pieces of sampling point data obtained in a last round can be used for the FFT process. In embodiments of the present disclosure, based on the frequency conversion and the extraction process, only N/n (n being the extraction rate) pieces of sampling point data are needed for the FFT process to reduce the data processing amount of the FFT. Thus, the processing efficiency can be improved, and the processing time consumption and the delay can be reduced.

For the plurality of FFT processes required to calculate a target parameter (such as the moving speed or movement distance of the object) once, a plurality of rounds of sampling can be performed to obtain the sampling point data needed for the plurality of FFT processes. Each round of sampling can correspond to one FFT process. In some embodiments, a sliding-window sampling method can be used for sampling. In this sampling method, the target point number N pieces of sampling point data can be obtained by sampling based on the sampling rate (the target frequency) in the first round. In a subsequent round other than the first round, only the sampling point number L₂ of pieces of sampling point data can be sampled. Then, the L₂ of pieces of sampling point data can be combined with L₁ of pieces of the neighboring previous round of sampling data to obtain the target point number N of pieces of sampling point data required in the current round. L₁ can be a sliding step of the sliding window in different rounds of sampling, where 1≤L₁≤N, 1≤L₂≤N, and L₁+L₂=N. Due to the sampling strategy in the present disclosure, only N/n (where n is the sampling rate) pieces of sampling point data can actually participate in the FFT process. Therefore, in practical applications, the L₂ pieces of sampling point data collected in the current round can be sampled at the sampling rate n to obtain L₂/n pieces of sampling point data, which can be then combined with the last L₁/n pieces of sampling point data from the N/n pieces of sampling point data used in the previous round of FFT process to obtain the N/n pieces of sampling point data required for the current round of FFT process.

The target point number can be 8192, and the sampling rate can be 8. For example, each sampling can include 960 pieces of point data. After the current FFT is completed for each round, the first 960 pieces of point data from the 8192 can be dropped based on the window sliding strategy. The 960 pieces of point data entering through the sampling can be combined with the last (8192−960) pieces of point data from the 8192 pieces of point sampling data of the current round to obtain the target number 8192 pieces of sampling point data required by the next round of FFT process. For the present disclosure, through the sampling strategy, the FFT process can only be performed on 8192/8=1024 pieces of sampling point data obtained through the sampling. Thus, for the non-first round FFT process, the 960/8 pieces of sampling point data obtained based on sampling and extraction can be combined with the last (8192−960)/8 pieces of sampling point data from the 1024 pieces of point data participating in the last round of FFT process to obtain the required 1024 pieces of sampling point data for FFT process.

For the first round of sampling, the required target point number of sampling point data can be obtained by adding zeros. For example, assuming the target point number can be 8192, and 960 points can be collected each time. For the first round of sampling, 960×8 points of sampling point data sequence can first be obtained through 8 times of sampling. Then, (8192−960×8) points of zero-value data can be added at the beginning of this sequence to obtain the 8192 points of sampling point data required for the current (first) round of the FFT process.

In embodiments of the present disclosure, by performing certain processing (frequency conversion and extraction) on the sampled echo signal before performing the Fourier transform, the frequency resolution can be obtained based on fewer data amount/computation amount by performing the FFT in the existing technology based on the higher data amount/computation amount. Thus, the data processing amount of the FFT can be reduced, the processing efficiency can be improved, and the time consumption and delay can be reduced.

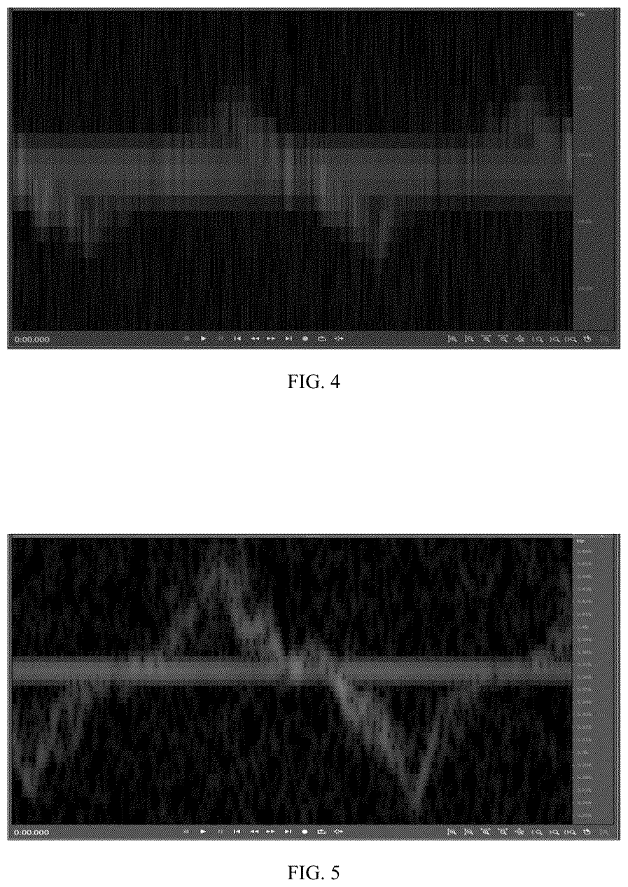

FIG. 4 and FIG. 5 illustrate Doppler effect diagrams after the FFT processes. The horizontal axis represents time, and the vertical axis represents frequency. To calculate the approaching distance of the object, a FFT process needs to be performed on the echo signal. FIG. 4 shows the Doppler effect obtained by directly performing a 1024-point FFT on the original echo signal using the existing technology. The frequency resolution can be poor. To achieve the effect shown in FIG. 5, the FFT process of the 8192 pieces of point data can be performed on the existing technology. In the method of the present disclosure, after the frequency conversion and extraction, only an FFT process of 1024 pieces of point data may need to be performed to achieve the effect of FIG. 5. The computation amount of the frequency conversion and the extraction can be ignored compared to the FFT process of 8192 pieces of point data. Thus, in the present disclosure, with a smaller data amount/computation amount, the frequency resolution of the echo signal can be obtained when performing the FFT with a higher data amount/computation amount in the existing technology.

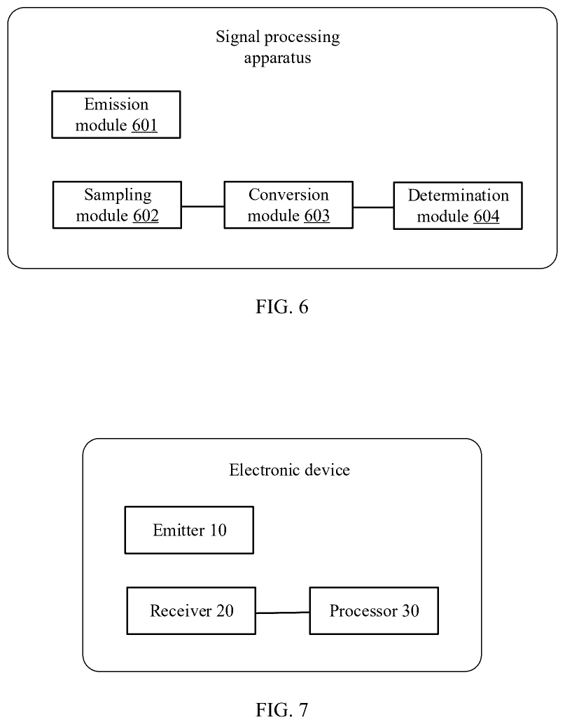

Corresponding to the above signal processing method, embodiments of the present disclosure also provide a signal processing apparatus. FIG. 6 illustrates the structural diagram of the signal processing apparatus, including an emission module 601, a sampling module 602, a conversion module 603, and a determination module 604.

The transmission module 601 can be configured to emit a target sound wave at a first frequency.

The sampling module 602 can be configured to sample based on the target frequency to obtain the target point number of sampling points. The target point number of sampling points can be used to restore the echo signal generated when the target sound wave of the first frequency encounters the object.

The conversion module 603 can be configured to convert the echo signal of the first frequency into the echo signal of the second frequency. The first frequency belongs to the first range, and the second frequency belongs to the second range. The minimum value of the first range is greater than the maximum value of the second range.

The determination module 604 can be configured to determine the target parameter of the object based on the echo signal at the second frequency. The target parameter is the parameter related to the position of the object.

In some embodiments, the conversion module 603 can be configured to multiply the echo signal of the first frequency by the cosine wave of the corresponding frequency to obtain the echo signal of the second frequency.

In some embodiments, the determination module 604 can be further configured to extract the sample points from the echo signal of the second frequency to obtain the sampling point data signal formed by the extracted sample point data, perform time-frequency domain conversion process on the sample-point data signal to convert the sample-point data signal from the time domain to the frequency domain, and determine the target parameter of the object based on the time-frequency domain conversion result of the sample-point data signal.

In some embodiments, when performing the time-frequency domain conversion process on the sample point data signal, the determination module 604 can be further configured to perform a Fourier transform on the sample-point data signal.

In some embodiments, the object can be the moving object.

When determining the target parameter of the object based on the time-frequency domain conversion result for the sample point data signal, the determination module 604 can be configured to determine the shift between the frequency of the echo signal of the target sound wave and the frequency of the target sound wave based on the time-frequency domain conversion result of the sample point data signal, and determine at least one of the distance between the objects, the moving speed of the object, or the moving distance based on the frequency shift.

In some embodiments, the above apparatus can further include a filter module, configured to filter out an invalid signal in the echo signal of the first frequency to convert the echo signal of the first frequency after the invalid signal is filtered out into the echo signal of the second frequency.

Embodiments of the present disclosure can further provide an electronic device. As shown in FIG. 7, the electronic device includes an emitter 10, a receiver 20, and a processor 30.

The emitter 10 can be configured to emit the target sound wave of the first frequency.

The receiver 20 can be configured to receive the echo signal generated when the target sound wave of the first frequency encounters the object. The echo signal can be restored through the target point number of sampling points obtained by sampling based on the target frequency.

The processor 30 can be configured to determine the target parameter of the object based on the echo signal received by the receiver. The target parameter is the parameter related to the position of the object. Determining the target parameter of the object includes converting the echo signal of the first frequency into the echo signal of the second frequency. The first frequency belongs to the first range, the second frequency belongs to the second range. The minimum value of the first range is greater than the maximum value of the second range.

For the process of the processor 30 determining the target parameter of the object based on the received echo signal (i.e., the echo signal of the first frequency), reference can be made to the related description above, which is not repeated here.

Various embodiments of the present disclosure are described in a progressive manner. Each embodiment focuses on the differences from other embodiments. The same or similar parts between embodiments of the present disclosure can be referred to each other.

To facilitate the description, the above system or apparatus can be described by dividing functions into various modules or units. When the present disclosure is implemented, the functions of the units can be implemented in the same or a plurality of pieces of software and/or hardware.

Through the description of the above embodiments, those skilled in the art can clearly understand that the present disclosure can be implemented by software plus a necessary general hardware platform. Based on this understanding, in the technical solution of the present disclosure, the essence or the part contributing to the existing technology can be embodied in the form of a software product. This computer software product can be stored in a storage medium, such as ROM/RAM, magnetic disks, optical disks, etc., and include instructions for causing a computer device (e.g., a personal computer, server, or network device) to execute the methods described in the various embodiments or parts of the embodiments of the present disclosure.

In the present disclosure, relational terms such as first, second, third, and fourth are used merely to distinguish one entity or operation from another, without necessarily requiring or implying any actual relationship or order between these entities or operations. Moreover, the terms “include,” “comprise,” or any other variation thereof are intended to cover non-exclusive inclusion, so that a process, method, article, or device that includes a series of elements includes not only those elements but also other elements not explicitly listed, or elements inherent to such process, method, article, or device. Without further limitation, an element defined by the phrase “comprising one . . . ” does not exclude the presence of additional identical elements in the process, method, article, or device that includes the element.

The above are only some embodiments of the present disclosure. For those of ordinary skill in the art, several improvements and modifications can be made without departing from the principles of the present disclosure, and these improvements and modifications should also be within the scope of the present disclosure.

What is claimed is:

1. A signal processing method comprising:
emitting a target sound wave of a first frequency;
sampling based on a target frequency to obtain a target point number of sampling points, wherein the target point number of sampling points are used to restore an echo signal generated when the target sound wave of the first frequency encounters an object;
converting the echo signal of the first frequency to an echo signal of a second frequency, wherein the first frequency belongs to a first range, the second frequency belongs to a second range, and a minimum value of the first range is greater than a maximum value of the second range; and
determining a target parameter of the object based on the echo signal of the second frequency, wherein the target parameter is related to a position of the object.

2. The signal processing method according to claim 1, wherein converting the echo signal of the first frequency to the echo signal of the second frequency includes:
multiplying the echo signal of the first frequency by a cosine wave of a corresponding frequency to obtain the echo signal of the second frequency.

3. The signal processing method according to claim 1, wherein determining the target parameter of the object based on the echo signal of the second frequency includes:
extracting sample points from the echo signal of the second frequency to obtain a sample point data signal formed by the extracted sample point data;
performing time-frequency domain conversion on the sample-point data signal to convert the sample point data signal from a time domain to a frequency domain; and
determining the target parameter of the object based on a time-frequency domain conversion result of the sample-point data signal.

4. The signal processing method according to claim 3, wherein performing the time-frequency domain conversion on the sample-point data signal includes:
performing a Fourier transform on the sample-point data signal.

5. The signal processing method according to claim 3, wherein:
the object is a moving object; and
determining the target parameter of the object based on the time-frequency domain conversion result of the sample-point data signal includes:
determining a frequency shift between the echo signal of the target sound wave and the target sound wave based on the time-frequency domain conversion result; and
determining at least one of a distance to the object, a moving speed of the object, or a movement distance of the object based on the frequency shift.

6. The signal processing method according to claim 1, further comprising, before converting the echo signal of the first frequency into the echo signal of the second frequency:
filtering out an invalid signal from the echo signal of the first frequency to convert the filtered echo signal of the first frequency into the echo signal of the second frequency.

7. A signal processing apparatus, comprising:
an emission module configured to emit a target sound wave of a first frequency;
a sampling module configured to sample based on a target frequency to obtain a target point number of sampling points, wherein the target point number of sampling points are used to restore an echo signal generated when the target sound wave of the first frequency encounters an object;
a conversion module configured to convert the echo signal of the first frequency into an echo signal of a second frequency, wherein the first frequency belongs to a first range, the second frequency belongs to a second range, and a minimum value of the first range is greater than a maximum value of the second range; and
a determination module configured to determine a target parameter of the object based on the echo signal of the second frequency, wherein the target parameter is related to a position of the object.

8. The signal processing apparatus according to claim 7, wherein the conversion module is further configured to:
multiply the echo signal of the first frequency by a cosine wave of a corresponding frequency to obtain the echo signal of the second frequency.

9. The signal processing apparatus according to claim 7, wherein the determination module is further configured to:
extract sample points from the echo signal of the second frequency to obtain a sample point data signal formed by the extracted sample point data;
perform time-frequency domain conversion on the sample-point data signal to convert the sample point data signal from a time domain to a frequency domain; and
determine the target parameter of the object based on a time-frequency domain conversion result of the sample-point data signal.

10. An electronic device comprising:
an emitter configured to emit a target sound wave of a first frequency;
a receiver configured to receive an echo signal generated when the target sound wave of the first frequency encounters an object, wherein the echo signal is restored through a target point number of sampling points obtained by sampling based on a target frequency; and
a processor configured to determine a target parameter of the object based on the echo signal received by the receiver and converting the echo signal of the first frequency into an echo signal of a second frequency, wherein the target parameter is related to a position of the object;
wherein the first frequency belongs to a first range, the second frequency belongs to a second range, and a minimum value of the first range is greater than a maximum value of the second range.

11. The electronic device according to claim 10, wherein the processor can be further configured to:
multiply the echo signal of the first frequency by a cosine wave of a corresponding frequency to obtain the echo signal of the second frequency.

12. The electronic device according to claim 10, wherein the processor is further configured to:
extract sample points from the echo signal of the second frequency to obtain a sample point data signal formed by the extracted sample point data;
perform time-frequency domain conversion on the sample-point data signal to convert the sample point data signal from a time domain to a frequency domain; and
determine the target parameter of the object based on a time-frequency domain conversion result of the sample-point data signal.

13. The electronic device according to claim 12, wherein the processor is further configured to:
perform a Fourier transform on the sample-point data signal.

14. The electronic device according to claim 12, wherein:
the object is a moving object; and
the processor is further configured to:
determine a frequency shift between the echo signal of the target sound wave and the target sound wave based on the time-frequency domain conversion result; and
determine at least one of a distance to the object, a moving speed of the object, or a movement distance of the object based on the frequency shift.

15. The electronic device according to claim 10, wherein the processor is further configured to:
filter out an invalid signal from the echo signal of the first frequency to convert the filtered echo signal of the first frequency into the echo signal of the second frequency.
